(19) United States
(12) Patent Application Publication
(10) Pub. No.: US 2025/0338072 A1
(43) Pub. Date: Oct. 30, 2025

(54) HEARING AID THAT FACILITATES EASY BATTERY REPLACEMENT

(71) Applicant: Yeasound (Xiamen) Hearing Technology Co., Ltd, Xiamen (CN)

(72) Inventor: Mingqiang Fu, Xiamen (CN)

(21) Appl. No.: 19/192,411

(22) Filed: Apr. 29, 2025

(30) Foreign Application Priority Data
Apr. 29, 2024 (CN) 202410525374.9

(51) Int. Cl. H04R 25/00

(52) U.S. Cl. CPC H04R 25/602; H04R 2225/31

(57) ABSTRACT

A hearing aid that facilitates easy battery replacement comprises a mounting frame, a battery body, an FPC-connecting member, and a metal sheet. The mounting frame is provided with a mounting groove; The battery body is detachably mounted in the mounting groove and comprises first and second electrode contact areas; The FPC-connecting member is combined with the mounting frame to accommodate the battery body and comprises an FPC-connecting board. A side of the FPC-connecting board facing the battery body is provided with first and second electrode spring plates, and the first electrode spring plate is connected with the first electrode contact area of the battery body; The metal sheet has a first end connected with the second electrode contact area of the battery body and a second end connected with the second electrode spring plate. The disclosure can achieve easy and convenient battery replacement.

### CROSS-REFERENCE TO PRIOR APPLICATION

This application claims the benefit of the priority of Chinese Patent Application No. 202410525374.9 filed on Apr. 29, 2024, the contents of which are incorporated herein by reference.

### TECHNICAL FIELD

The disclosure relates to the technical field of hearing aids, more particularly to a hearing aid that facilitates easy battery replacement.

### BACKGROUND

Rechargeable hearing aids typically employ button-type lithium batteries, which have a limited number of charging cycles and a service life of merely 2-3 years. However, as medical devices, the hearing aids are expected to offer a service life of over 5 years. Consequently, during the service life of rechargeable hearing aids, battery replacement is required. To ensure reliability, rechargeable batteries in the market are typically connected to circuit boards via bonding wires. Thus, to allow for battery replacement, desoldering and resoldering processes are required. However, these processes cannot be directly carried out at fitting centers, and the hearing aids to be recharged need to be sent back to the original factory for battery assembly and then sent back to users. It takes a long time for battery replacement, and users are required to wait for a period of time to get their hearing aids back, resulting in considerable inconvenience.

### SUMMARY

The disclosure is to solve a technical problem of how to allow for convenient battery replacement.

In order to solve the above technical problem, the disclosure provides a hearing aid that facilitates easy battery replacement, comprising:
a mounting frame provided with a mounting groove;
a battery body detachably mounted in the mounting groove and comprising a first electrode contact area and a second electrode contact area;
an FPC-connecting member, which is combined with the mounting frame to accommodate the battery body, wherein the FPC-connecting member comprises an FPC-connecting board, a side of the FPC-connecting board facing the battery body is provided with a first electrode spring plate and a second electrode spring plate, and the first electrode spring plate is connected with the first electrode contact area of the battery body; and
a metal sheet comprising a first end connected with the second electrode contact area of the battery body and a second end connected with the second electrode spring plate.

Further preferably, the first electrode contact area may be either positive electrode contact area or negative electrode contact area, the first electrode contact area and the second electrode contact area may have opposite polarities, the first electrode contact area and the first electrode spring plate may have same polarity, and the second electrode contact area and the second electrode spring plate may have same polarity.

Further preferably, the first electrode contact area may be negative electrode contact area, the second electrode contact area may be positive electrode contact area, the first electrode contact area may be positioned at a bottom surface of the battery body, and the second electrode contact area may be positioned at a side surface of the battery body.

Further preferably, the metal sheet may be adhered with the first electrode contact area by using an insulating double-sided adhesive, and the metal sheet may be provided at a center portion with a first through-hole for allowing the first electrode contact area to be at least partially exposed to outside.

Further preferably, the first end of the metal sheet may be provided with a pin in contact with the second electrode contact area.

Further preferably, the FPC-connecting member may be disposed directly below the mounting groove and fitting on a bottom portion of the mounting frame.

Further preferably, the battery body may further include a positive electrode surface, wherein the positive electrode surface and the first electrode contact area may be spaced apart from each other and respectively arranged at two opposite ends of the battery body; and the positive electrode surface, the second electrode contact area, and an outer edge portion of the metal sheet may be coated with an insulating protective layer to form an insulating protective layer region.

Further preferably, a boundary line of the insulating protective layer may be defined on a surface of the metal sheet, and a masked region may be defined by the area within the boundary line of the insulating protective layer, the metal sheet may be at least partially exposed in the masked region to form a second electrode contact area within the masked region, and the second electrode spring plate may abut against the second electrode contact area within the masked region.

Further preferably, the insulating double-sided adhesive between the first electrode contact area and the metal sheet may be provided at a center portion with a second through-hole that is concentric with the first through-hole, the first electrode spring plate may abut against the first electrode contact area through the second through-hole, and the second through-hole may have a diameter smaller than that of the first through-hole.

Further preferably, a sealing gasket may be provided, which may be adhered to a bottom portion of the mounting groove and fit on the insulating protective layer region at the outer edge portion of the metal sheet, such that an enclosed region is defined between the battery body and the FPC-connecting board, and the second electrode spring plate and the first electrode spring plate are located in the enclosed region.

Further preferably, the sealing gasket may be a ring-shaped rubber gasket or a ring-shaped silicone gasket.

Further preferably, a housing may be provided, the mounting frame may be detachably mounted in the housing, an inner top wall of the housing may be provided with a battery pad, and the battery pad may be adhered to the positive electrode surface of the battery body.

Further preferably, the battery pad may be a foam pad.

Further preferably, a side of the FPC-connecting member facing away from the mounting frame may be provided with a wireless coil, which abuts against an inner bottom wall of the housing and is connected to the bottom portion of the mounting frame.

Further preferably, a main FPC board may be provided, which may be positioned on an inner side of the mounting frame, the FPC-connecting member may comprise a bent portion extension, and the bent portion extension may have one end connected to an outer edge of the FPC-connecting board and another end welded to the main FPC board.

Further preferably, the second electrode spring plate and the first electrode spring plate may be inclinedly arranged on the FPC-connecting board, the second electrode spring plate and the FPC-connecting board may form an acute angle of 30°-45°, and the first electrode spring plate and the FPC-connecting board may also form an acute angle of 30°-45°.

Further preferably, the metal sheet may have a cross-sectional shape identical to that of the battery body.

Compared with the existing technologies, the hearing aid that facilitates easy battery replacement of the disclosure has advantages as follows.

The disclosure achieves mounting of the battery body by providing the mounting groove on the mounting frame. Furthermore, with the arrangement of the metal sheet, two electrodes of the battery can be provided at same side of the battery to facilitate connection with the electrode spring plates of the FPC-connecting member, eliminating the need for welding the battery on the circuit board or the FPC-connecting member and realizing the detachable battery. In particular, the metal sheet includes the first end and the second end, the second electrode contact area of the battery body can be converted to a position at a same plane with the first electrode contact area due to the first end. In the case that the battery body is disposed in the mounting groove, the second electrode spring plate and the first electrode spring plate can respectively abut against the metal sheet and the first electrode contact area, respectively, thereby ensuring convenience in easy battery replacement and eliminating the need for battery desoldering and resoldering processes. Due to the contact by spring plates, it enables easy battery replacement that can be carried out at the fitting center, eliminating the need to return to the original factory for processing.

### BRIEF DESCRIPTION OF THE DRAWINGS

FIG. 1 is an exploded view (without any housing) of a hearing aid that facilitates easy battery replacement according to the disclosure;

FIG. 2 is a structural schematic view of a battery body according to the disclosure;

FIG. 3 is a structural schematic view of a battery body coated with an insulating protective layer according to the disclosure;

FIG. 4 illustrates a schematic view in which a battery body and a mounting frame are assembled according to the disclosure;

FIG. 5 illustrates a schematic view in which a battery body, a mounting frame, and a housing are assembled according to the disclosure.

### IN THE DRAWINGS

1. battery pad;
2. battery body; 2a. second electrode contact area; 2b. metal sheet; 2c. first electrode contact area; 2d. insulating double-sided adhesive; 2e. boundary line of insulating protective layer; 2f. second electrode contact area within masked region; 2g. insulating protective layer region; 21. second end of metal sheet; 22. first end of metal sheet; 23. first through-hole; 24. second through-hole; 25. pin; 26. positive electrode surface;
3. sealing gasket;
4. mounting frame; 41. mounting groove 41;
5. FPC-connecting member; 5a. FPC-connecting board; 5b. second electrode spring plate; 5c. first electrode spring plate; 5d. bent portion extension;
6. wireless coil;
7. main FPC board;
8. housing.

### DETAILED DESCRIPTION OF ILLUSTRATED EMBODIMENTS

The particular embodiments of the disclosure will be further explained below in detail with reference to figures and examples. The following examples serve to illustrate the present invention, but are not intended to limit the present invention.

It should be understood that the terms, such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial” and “circumferential” as used in the description of the disclosure, refer to position and orientation relationships as shown in the drawings for convenience of description and for the purpose of simplicity. They are not intended to indicate or hint a limitation in terms of specific orientation or configuration and operation with specific orientation to the described device or element, and should not be regarded as a limitation to the present disclosure.

The terms “first” and “second” are used for description and are not intended to indicate or imply relative importance or hint the quantity of elements. Hence, the elements defined by the terms “first” and “second” are intended to indicate or hint that one or more of such elements are provided. Unless explicitly specified otherwise, “plurality” as used in the description refer to at least two, for instance, two, three, and so on.

Furthermore, unless explicitly defined or specified otherwise, the terms “mount”, “connect” and “attach” are intended to be understood in a broad sense. For example, they may refer to fixedly connect, or detachably connect, or integrally connect; or mechanically connect, or electrically connect; or directly connect, or indirectly connect via an intermedium, or internally communicate between two components. The particular meanings of the terms used herein may be understood by those skilled in the art in accordance with specific conditions.

Unless explicitly defined or specified otherwise, a first feature is located “above” or “below” a second feature as described in the description, may indicate that the first and second features are directly contacted with each other, or the first and second features are indirectly contacted via an intermedium. Furthermore, the description that the first feature is located “on”, “above” or “over” the second feature may indicate that the first feature is located right above or obliquely above the second feature, or merely indicate that the first feature is located at a position with a horizontal height higher than the second feature. The description that the first feature is located “under”, “below” or “underneath” the second feature may indicate that the first feature is located right below or obliquely below the second feature, or merely indicate that the first feature is located at a position with a horizontal height lower than the second feature.

It should be noted that an element referred to as being “fixedly arranged” or “disposed” at a further element may be located on the further element directly or via an intermediate element, and an element referred to as being “connected with” a further element may be connected with the further element directly or via an intermediate element. The terms such as “perpendicular”, “horizontal”, “up”, “down”, “left”, and “right” and the like as used herein are merely for illustrative purposes and do not imply any limitation in terms of implementation.

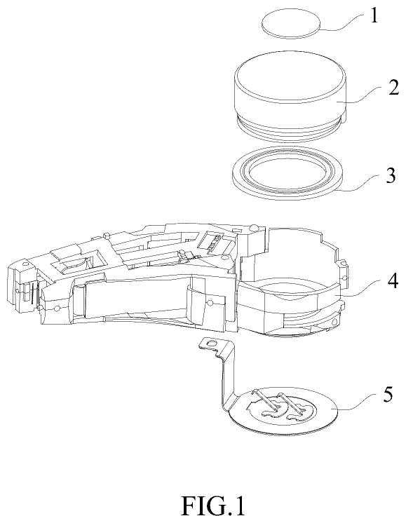

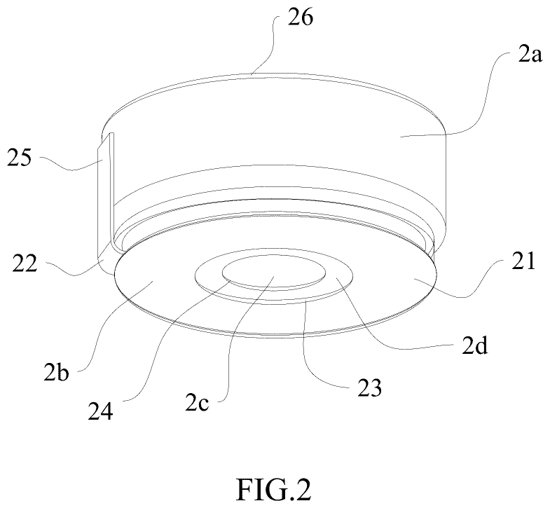

Referring to FIGS. 1-5, the hearing aid that facilitates easy battery replacement in the present embodiment comprises a battery body 2, a metal sheet 2b, a mounting frame 4, and an FPC-connecting member 5.

In a particular implementation, the mounting frame 4 is provided with a mounting groove 41. The battery body 2 is detachably mounted in the mounting groove 41. The battery body includes a first electrode contact area 2c and a second electrode contact area 2a. The FPC-connecting member 5 and the mounting frame 4 are combined to accommodate the battery body 2. The FPC-connecting member 5 comprises an FPC-connecting board 5a, the side of the FPC-connecting board 5a facing the battery body 2 is provided with a first electrode spring plate 5c and a second electrode spring plate 5b, and the first electrode spring plate 5c is connected with the first electrode contact area 2c of the battery body 2. The metal sheet 2b includes a second end 21 and a first end 22, wherein the first end 22 of the metal sheet 2b is connected with the second electrode contact area 2a of the battery body 2, the second end 21 of the metal sheet 2b is connected with the second electrode spring plate 5b. In this way, the mounting groove 41 provided on the mounting frame 4 can facilitate the mounting of the battery body 2. Furthermore, by designing the metal sheet 2b to realize that both of the two electrodes of the battery are at same side of the battery and abut against the electrode spring plates of the FPC-connecting member 5, it eliminates the need for welding the battery on the circuit board or the FPC-connecting member 5, thereby realizing the detachable battery. In particular, the metal sheet 2b includes the first end 22 and the second end 21, and the first end 22 of the metal sheet 2b and the first electrode contact area 2c are oppositely arranged. Due to the first end 22, the second electrode contact area 2a of the battery body 2 can be converted to a position at a same plane with the first electrode contact area 2c. In the case that the battery body 2 is disposed in the mounting groove 41, the second electrode spring plate 5b and the first electrode spring plate 5c can abut against the metal sheet 2b and the first electrode contact area 2c, respectively, thereby ensuring convenience in easy battery replacement and eliminating the need for battery desoldering and resoldering processes. Due to the contact by spring plates, it enables easy battery replacement that can be carried out at the fitting center, eliminating the need to return hearing aids with the battery to the original factory for processing.

In some implementations, the first electrode spring plate 5c and the first electrode contact area 2c of the battery body 2 are connected by detachable connection, the second end 21 of the metal sheet 2b and the second electrode spring plate 5b are connected by detachable connection, preferably abutment contact, or alternatively, plug-in connection, threaded connection, clamping connection, magnetic connection, etc., which are not limited herein.

In some implementations, the first electrode contact area 2c may be either positive electrode contact area or negative electrode contact area. The first electrode contact area 2c and the second electrode contact area 2a have opposite polarities. The first electrode contact area 2c and the first electrode spring plate 5c have same polarity. The second electrode contact area 2a and the second electrode spring plate 5b have same polarity. Preferably, the first electrode contact area 2c is negative electrode contact area, while the second electrode contact area 2a is positive electrode contact area. The first electrode contact area 2c is located at the bottom surface of the battery body 2, while the second electrode contact area 2a is located at the side surface of the battery body 2. In particular, the first end 22 of the metal sheet 2b is provided with a pin 25 in contact with the second electrode contact area 2a, and the positive electrode of the battery body 2 is led to the second end 21 of the metal sheet 2b by the pin 25, such that both positive and negative electrodes of the battery body 2 combined with the metal sheet 2b are provided at the bottom surface of the battery body 2. In the case that the battery body 2 combined with the metal sheet 2b is disposed in the mounting groove 41, the second electrode spring plate 5b and the first electrode spring plate 5c can abut against the metal sheet 2b and the first electrode contact area 2c, respectively, thereby achieving convenience in easy battery replacement under the premise of ensuring the battery's normal operation and eliminating the need for battery desoldering and resoldering processes. Due to the contact by spring plates, it enables easy battery replacement that can be carried out at the fitting center, eliminating the need to return hearing aids with the battery to the original factory for processing.

In some implementations, in order to prevent direct contact between positive and negative electrodes of the battery body 2, the metal sheet 2b is adhered with the first electrode contact area 2c by using the insulating double-sided adhesive 2d, to achieve isolation between positive and negative electrodes of the battery body 2 and avoid short circuits that could affect the use of battery.

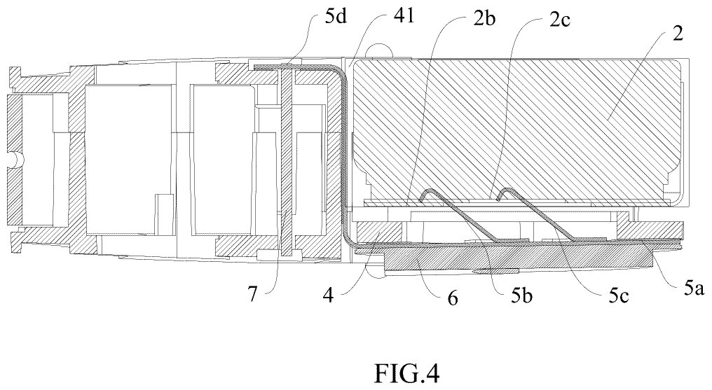

In a particular implementation, the mounting frame 4 is provided with the mounting groove 41; the battery body 2 is detachably mounted in the mounting groove 41, as shown in FIG. 1. The battery body 2 includes the second electrode contact area 2a and the first electrode contact area 2c, the metal sheet 2b is provided at its first end 22 with a pin 25 which is in contact with the second electrode contact area 2a. With the arrangement of the metal sheet 2b, the positive contact region of the battery body 2 can be converted to a bottom periphery-ring contact area, such that both the positive and negative electrodes of the battery body 2 can be positioned at a same plane on the bottom surface. The metal sheet 2b is provided at its center portion with a first through-hole 23 which allows the first electrode contact area 2c to be at least partially exposed to the outside; The FPC-connecting member 5 is disposed directly below the mounting groove 41 and fits on the bottom portion of the mounting frame 4. Referring to FIG. 4, the FPC-connecting member 5 comprises the FPC-connecting board 5a, and the side of the FPC-connecting board 5a facing the battery body 2 is provided with the second electrode spring plate 5b and the first electrode spring plate 5c. The second electrode spring plate 5b abuts against the metal sheet 2b, and the first electrode spring plate 5c abuts against the first electrode contact area 2c, whereby the FPC-connecting member 5 is disposed directly below the mounting groove 41. In the case that the battery body 2 is disposed in the mounting groove 41, the second electrode spring plate 5b and the first electrode spring plate 5c can abut against the metal sheet 2b and the first electrode contact area 2c, respectively, thereby ensuring convenience in easy battery replacement and eliminating the need for battery desoldering and resoldering processes. Due to the spring tab contact, it enables easy battery replacement that can be carried out at the fitting center, eliminating the need to return to the original factory for processing.

In the above implementation, the pin 25 may be directly connected with the second electrode contact area 2a by welding connection, or indirectly connected with it by conductive adhesive.

In the above implementation, the second end 21 of the metal sheet 2b has a cross-sectional shape identical to that of the battery body 2. Preferably, they may have concentric circles or ovals for the convenience of position alignment and assembly.

In the above implementation, the metal sheet 2b is preferably a nickel metal sheet, which has characteristics of good electrical conductivity, ease of welding, and good solderability. In other implementations, the metal sheet 2b may also be a stainless-steel carbon sheet or a beryllium copper spring tab.

In some implementations, the FPC-connecting member 5 is positioned directly below the mounting groove 41 and fits on the bottom portion of the mounting frame 4. The FPC-connecting member 5 and the mounting frame 4 may be connected by threaded connection, snap-fit connection, or adhesive connection.

In further implementations, the FPC-connecting member 5 may be disposed at any position on the side surface of the mounting groove 41, or at any position above the battery body 2. The position alignment among the FPC-connecting member 5, the metal sheet 2b, and the battery body 2 can be achieved, for example by snap-fit or shape matching therebetween, to realize the connection between the first electrode spring plate 5c and the first electrode contact area 2c, the connection between the first end 22 of the metal sheet 2b and the second electrode contact area 2a, and the connection between the second end 21 of the metal sheet 2b and the second electrode spring plate 5b of the FPC-connecting member 5. In this way, due to the metal sheet 2b, the battery body 2 in the hearing aid can be connected with the FPC-connecting member 5 at a same plane through spring plates, eliminating the need for soldering the battery body 2 in the hearing aid and realizing the detachable battery design.

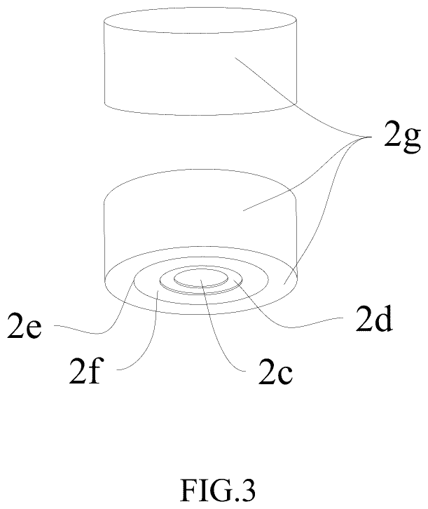

In some implementations, referring to FIG. 3 to facilitate understanding, the battery body 2 further includes a positive electrode surface 26. The positive electrode surface 26 is spaced apart from the first electrode contact area 2c, and they are respectively arranged at two opposite ends of the battery body 2. To ensure the reliability and waterproofness of the battery, the positive electrode surface 26 of the battery body 2, the second electrode contact area 2a, and the outer edge portion of the metal sheet 2b are coated with an insulating protective layer, forming an insulating protective layer region 2g. A boundary line 2e of the insulating protective layer is defined on the surface of the metal sheet 2b, and a masked region (i.e., uncoated with insulating protective layer) is defined within the boundary line 2e of the insulating protective layer. The metal sheet 2b is at least partially exposed in the masked region, to form a second electrode contact area 2f within the masked region. The second electrode spring plate 5b abuts against the second electrode contact area 2f within the masked region. In this way, due to the arrangement of insulating protective layer, the metal sheet 2b and the battery body 2 can form an integral structure with only the second electrode contact area 2f within the masked region and the first electrode contact area 2c being exposed to the outside, thereby allowing the second electrode spring plate 5b and the first electrode spring plate 5c to abut thereon and thus ensuring the reliability of the battery.

In some implementations, the insulating protective layer is preferably a Parylene coating film, which exhibits excellent chemical stability, high insulating property, and great protective performance. In further implementations, the insulating protective layer may be a silicone coating film, polyurethane coating, fluoropolymer coating, metallic coating (such as chrome-plated or nickel-plated layers), or a nanocoating.

In some implementations, in order to prevent direct contact between the positive and negative electrodes of the battery body 2, the metal sheet 2b is adhered to the first electrode contact area 2c by an insulating double-sided adhesive 2d. In this way, the positive and negative electrodes of the battery body 2 can be isolated to avoid short circuits that could affect the use of battery.

Continuing with FIG. 3 to facilitate understanding, as the metal sheet 2b in the above implementation is provided at its center portion with the first through-hole 23, the first electrode spring plate 5c can abut against the first electrode contact area 2c through the first through-hole 23. Consequently, the insulating double-sided adhesive 2d between the first electrode contact area 2c and the metal sheet 2b is provided at its center portion with a second through-hole 24 that is concentric with the first through-hole 23. That is, the second through-hole 24 allows the center portion of the negative contact region to be exposed, and the first electrode spring plate 5c abuts against the first electrode contact area 2c through the second through-hole 24.

Besides, to enhance the reliability of battery operation, the second through-hole 24 may be limited to have a diameter smaller than that of the first through-hole 23. In such a case, an insulating region of a certain width can be defined between the second electrode contact area 2f, within the masked region, and the first electrode contact area 2c, thereby effectively avoiding accidental contact, between the second electrode spring plate 5b and the first electrode spring plate 5c, which could cause short circuits or even damage to the battery.

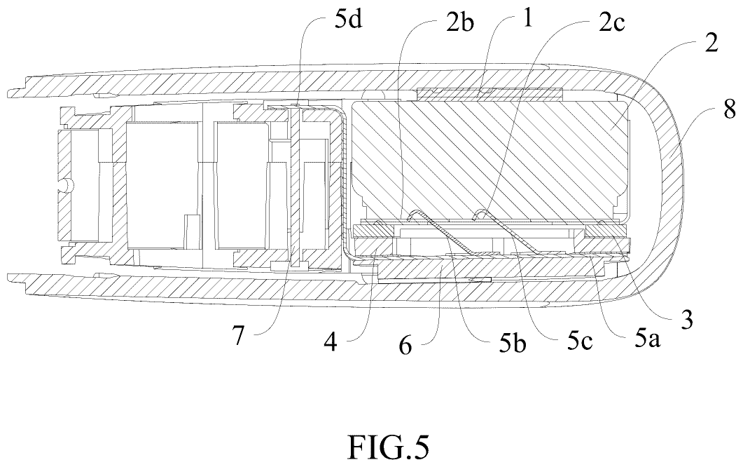

Referring to FIG. 5, in some implementations, in order to ensure a stable contact between the battery body 2 positioned in the mounting groove 41 and both the second electrode spring plate 5b and the first electrode spring plate 5c, the hearing aid that facilitates easy battery replacement further comprises a housing 8, the mounting frame 4 is detachably mounted in the housing 8, the inner top wall of the housing 8 is provided with a battery pad 1, and the battery pad 1 is adhered to the positive electrode surface 26 (coated with insulating protective layer) of the battery body 2. In this way, the battery pad 1 adhered to the positive electrode surface 26 of the battery body 2 can cooperate with the housing 8 to ensure an interference fit of the contact between the second electrode spring plate 5b and the bottom surface of the battery body 2 and an interference fit of the contact between the first electrode spring plate 5c and the bottom surface of the battery body 2, thereby facilitating a stable contact between the bottom surface of the battery body 2 and both the second electrode spring plate 5b and the first electrode spring plate 5c at all times. That is, the second electrode contact area 2f within the masked region abuts against the second electrode spring plate 5b at all times, and the first electrode contact area 2c abuts against the first electrode spring plate 5c at all times, thereby ensuring the reliability and stability of the operation of the battery body 2.

In a further implementation, the battery pad 1 is a foam pad. The foam which is elastic can provide a certain tensile force to the battery body 2 when adhered to the positive electrode surface 26 of the battery body 2, thereby ensuring a stable contact between the bottom surface of the battery body 2, that is combined with the metal sheet 2b, and both the second electrode spring plate 5b and the first electrode spring plate 5c at all times. Besides, the foam which has a characteristic of lightweight can facilitate the reduction in the weight of the hearing aid that facilitates easy battery replacement, thereby making it more convenient for users to carry and use.

In a further implementation, the battery body 2 can be fixed in the mounting groove 41 by snap fit. In such a case, the tensile force is applied to the battery body 2 by snap fit instead of the battery pad 1.

In some implementations, due to the relatively small thickness of the FPC-connecting member 5, a reaction force is applied to the FPC-connecting board 5a when the second electrode spring plate 5b and the first electrode spring plate 5c come into abutment with the battery body 2, causing a deformation and depression of the FPC-connecting board 5a. It may result in a poor contact between the second electrode spring plate 5b and the first electrode spring plate 5c and the battery body 2. Consequently, the side of the FPC-connecting member 5 facing away from the mounting frame 4 is provided with a wireless coil 6. The wireless coil 6 abuts against the inner bottom wall of the housing 8 and is connected to the bottom portion of the mounting frame 4. The wireless coil 6, which has a certain degree of rigidity and does not easily deform, can support the FPC-connecting board 5a against deformation and depression, and thus can ensure a stable connection between the second electrode spring plate 5b and the first electrode spring plate 5c and the battery body 2.

In the above implementation, the FPC-connecting member 5 and the mounting frame 4 are adhered and connected to each other by using the double-sided adhesive, and the wireless coil 6 is adhered and connected to the FPC-connecting member 5 by using the double-sided adhesive.

In some implementations, the second electrode spring plate 5b and the first electrode spring plate 5c are inclinedly arranged on the FPC-connecting board 5a. The second electrode spring plate 5b and the FPC-connecting board 5a can form an acute angle of 30°-45°, and the first electrode spring plate 5c and the FPC-connecting board 5a can also form an acute angle of 30°-45°. With such angle ranges, it can ensure contact by interference fits between the second electrode spring plate 5b and the battery body 2, as well as between the first electrode spring plate 5c and the battery body 2, thereby enhancing the reliability of the use of battery and effectively preventing poor contact caused by deformation of the second electrode spring plate 5b and/or the first electrode spring plate 5c.

In some implementations, the hearing aid that facilitates easy battery replacement further includes a main FPC board 7, the main FPC board 7 is positioned on the inner side of the mounting frame 4, the FPC-connecting member 5 further includes a bent portion extension 5d, and the bent portion extension 5d has one end connected to the outer edge of the FPC-connecting board 5a and the other end welded to the main FPC board 7, and then connected to the control chip.

In some implementations, the hearing aid that facilitates easy battery replacement further includes a sealing gasket 3. The sealing gasket 3 is adhered to the bottom portion of the mounting groove 41 and fits to the insulating protective layer region 2g on the outer edge of the metal sheet 2b, such that an enclosed region is defined between the battery body 2 and the FPC-connecting board 5a, and the second electrode spring plate 5b and the first electrode spring plate 5c are positioned in the enclosed region; In this way, under the action of the battery pad 1, sealing by interference fits can be provided between the sealing gasket 3 and both the battery body 2 and the mounting frame 4, and the fitting surface is exactly the insulating protective layer region 2g of the battery. Due to the circumferential sealing by the sealing gasket 3, the contact areas of the second electrode spring plate 5b with both the first electrode spring plate 5c and the battery body 2 are sealed in the enclosed region defined by the battery body 2, the FPC-connecting member 5, and the sealing gasket 3, thereby ensuring the reliability of the battery and the contact areas and also offering convenience for easy battery replacement.

In a further implementation, the sealing gasket 3 is a ring-shaped rubber gasket or a ring-shaped silicone gasket.

Accordingly, the hearing aid for easy battery replacement according to the embodiments of the disclosure can facilitate the mounting of the battery body 2 by providing the mounting groove 41 on the mounting frame 4. Furthermore, with the arrangement of the metal sheet 2b, the second electrode contact area of the battery body 2 can be converted to the bottom periphery-ring contact area, such that both the positive and negative electrodes of the battery body 2 can be positioned at the bottom surface of the battery body 2. As the metal sheet 2b is provided at its middle portion with the first through-hole 23 and the FPC-connecting member 5 is disposed directly below the mounting groove 41, in the case that the battery body 2 is disposed in the mounting groove 41, the second electrode spring plate 5b and the first electrode spring plate 5c can abut against the metal sheet 2b and the first electrode contact area 2c, respectively, thereby ensuring convenience in easy battery replacement and eliminating the need for battery desoldering and resoldering processes. Due to the contact with spring tabs, it enables easy battery replacement which can be carried out at the fitting center, eliminating the need to return the hearing device with the battery to the original factory for processing. Besides, the battery pad 1 adhered to the positive electrode surface 26 of the battery body 2 can cooperate with the housing 8 to ensure an interference fit of the contact between the second electrode spring plate 5b and the bottom surface of the battery body 2 and an interference fit of the contact between the first electrode spring plate 5c and the bottom surface of the battery body 2, thereby achieving a stable contact between the bottom surface of the battery body 2 and both the second electrode spring plate 5b and the first electrode spring plate 5c at all times. That is, the second electrode contact area 2f within the masked region abuts against the second electrode spring plate 5b at all times, and the first electrode contact area 2c abuts against the first electrode spring plate 5c at all times, thereby ensuring the reliability of the operation of the battery body 2. Under the action of the battery pad 1, sealing by interference fits can be provided between the sealing gasket 3 and both the battery body 2 and the mounting frame 4, and the fitting surface is exactly the insulating protective layer region 2g of the battery. Due to the circumferential sealing by the sealing gasket 3, the contact areas of the second electrode spring plate 5b with both the first electrode spring plate 5c and the battery body 2 are sealed in the enclosed region defined by the battery body 2, the FPC-connecting member 5, and the sealing gasket 3, thereby ensuring the reliability of the battery and the contact areas and also offering convenience for easy battery replacement.

All the above are merely some preferred embodiments of the disclosure. It should be noted that those skilled in the art may obtain modifications and equivalents without departing from the technical principle of the disclosure. The disclosure is intended to cover such modifications and equivalents. The basic principles, main features, and advantages of the present invention are illustrated and described above. Apparently, those skilled in the art can understand that the present invention is not limited to the details of the preferred embodiments. The embodiments should be regarded as exemplary and non-limiting. The scope of the present invention is defined by the appended claims rather than the foregoing description. The present invention is intended to cover all changes included within the essence and scope of the equivalent arrangements according to the claims of the disclosure.

Furthermore, it should be understood that though the present invention is described in terms of the embodiments, each of the embodiments should not be regarded as a technical solution independent from the others. The description is described in such a manner merely for clarity. The description should be considered as a whole by those skilled in the art, and the technical solutions of the embodiments can also be combined appropriately to form other embodiments that are conceivable for those skilled in the art.

1. A hearing aid that facilitates battery replacement, comprising:
a mounting frame provided with a mounting groove;
a battery body detachably mounted in the mounting groove and comprising a first electrode contact area and a second electrode contact area;
an FPC-connecting member, which is combined with the mounting frame to accommodate the battery body, wherein the FPC-connecting member comprises an FPC-connecting board, a side of the FPC-connecting board facing the battery body is provided with a first electrode spring plate and a second electrode spring plate, and the first electrode spring plate is connected with the first electrode contact area of the battery body; and
a metal sheet comprising a first end connected with the second electrode contact area of the battery body and a second end connected with the second electrode spring plate.

2. The hearing aid that facilitates battery replacement according to claim 1, wherein the first electrode contact area is either positive electrode contact area or negative electrode contact area, the first electrode contact area and the second electrode contact area have opposite polarities, the first electrode contact area and the first electrode spring plate have same polarity, and the second electrode contact area and the second electrode spring plate have same polarity.

3. The hearing aid that facilitates battery replacement according to claim 2, wherein the first electrode contact area is negative electrode contact area, the second electrode contact area is positive electrode contact area, the first electrode contact area is positioned at a bottom surface of the battery body, and the second electrode contact area is positioned at a side surface of the battery body.

4. The hearing aid that facilitates battery replacement according to claim 3, wherein the metal sheet is adhered to the first electrode contact area by using an insulating double-sided adhesive, and the metal sheet is provided at a center portion with a first through-hole for allowing the first electrode contact area to be at least partially exposed to outside.

5. The hearing aid that facilitates battery replacement according to claim 1, wherein the first end of the metal sheet is provided with a pin in contact with the second electrode contact area.

6. The hearing aid that facilitates battery replacement according to claim 1, wherein the FPC-connecting member is disposed directly below the mounting groove and fitting on a bottom portion of the mounting frame.

7. The hearing aid that facilitates battery replacement according to claim 4, wherein the battery body further include a positive electrode surface, the positive electrode surface and the first electrode contact area are spaced apart from each other and are respectively arranged at two opposite ends of the battery body; and the positive electrode surface, the second electrode contact area, and an outer edge portion of the metal sheet are coated with an insulating protective layer to form an insulating protective layer region.

8. The hearing aid that facilitates battery replacement according to claim 7, wherein a boundary line of the insulating protective layer is defined on a surface of the metal sheet, and a masked region is defined by an area within the boundary line of the insulating protective layer, the metal sheet is at least partially exposed in the masked region to form a second electrode contact area within the masked region, and the second electrode spring plate abuts against the second electrode contact area within the masked region.

9. The hearing aid that facilitates battery replacement according to claim 7, wherein the insulating double-sided adhesive between the first electrode contact area and the metal sheet is provided at a center portion with a second through-hole that is concentric with the first through-hole, the first electrode spring plate abuts against the first electrode contact area through the second through-hole, and the second through-hole has a diameter smaller than that of the first through-hole.

10. The hearing aid that facilitates battery replacement according to claim 7, further comprising a sealing gasket, which is adhered to a bottom portion of the mounting groove and fits on the insulating protective layer region at the outer edge portion of the metal sheet, such that an enclosed region is defined between the battery body and the FPC-connecting board, and the second electrode spring plate and the first electrode spring plate are located in the enclosed region.

11. The hearing aid that facilitates battery replacement according to claim 10, wherein the sealing gasket is a ring-shaped rubber gasket or a ring-shaped silicone gasket.

12. The hearing aid that facilitates battery replacement according to claim 7, further comprising a housing, the mounting frame is detachably mounted in the housing, an inner top wall of the housing is provided with a battery pad, and the battery pad is adhered to the positive electrode surface of the battery body.

13. The hearing aid that facilitates battery replacement according to claim 12, wherein the battery pad is a foam pad.

14. The hearing aid that facilitates battery replacement according to claim 12, wherein a side of the FPC-connecting member facing away from the mounting frame is provided with a wireless coil, which abuts against an inner bottom wall of the housing and is connected to a bottom portion of the mounting frame.

15. The hearing aid that facilitates battery replacement according to claim 1, further comprising a main FPC board, which is positioned on an inner side of the mounting frame, the FPC-connecting member comprises a bent portion extension, and the bent portion extension has one end connected to an outer edge of the FPC-connecting board and another end welded to the main FPC board.

16. The hearing aid that facilitates battery replacement according to claim 1, wherein the second electrode spring plate and the first electrode spring plate are inclinedly arranged on the FPC-connecting board, both an acute angle formed by the second electrode spring plate and the FPC-connecting board and an acute angle formed by the first electrode spring plate and the FPC-connecting board range from 30° to 45°.

17. The hearing aid that facilitates battery replacement according to claim 1, wherein the metal sheet has a cross-sectional shape identical to that of the battery body.

18. The hearing aid that facilitates battery replacement according to claim 2, wherein the second electrode spring plate and the first electrode spring plate are inclinedly arranged on the FPC-connecting board, both an acute angle formed by the second electrode spring plate and the FPC-connecting board and an acute angle formed by the first electrode spring plate and the FPC-connecting board range from 30° to 45°.

19. The hearing aid that facilitates battery replacement according to claim 8, wherein the second electrode spring plate and the first electrode spring plate are inclinedly arranged on the FPC-connecting board, both an acute angle formed by the second electrode spring plate and the FPC-connecting board and an acute angle formed by the first electrode spring plate and the FPC-connecting board range from 30° to 45°.

20. The hearing aid that facilitates battery replacement according to claim 4, wherein the metal sheet has a cross-sectional shape identical to that of the battery body.
